(19) United States
(12) Patent Application Publication
(10) Pub. No.: US 2020/0374385 A1
(43) Pub. Date: Nov. 26, 2020

(54) MOBILE PHONE CASE, AND CONTROLLING METHOD AND ELECTRONIC DEVICE USING THE SAME

(71) Applicant: pixelRo Co.LTD, Jiwang-si (KR)

(72) Inventor: Seok Myong KANG, Hwaseong-si (KR)

(21) Appl. No.: 16/708,819

(22) Filed: Dec. 10, 2019

(30) Foreign Application Priority Data
May 21, 2019 (KR) 10-2019-0059447

(51) Int. Cl. H04M 1/725; H04B 1/3888; H04W 12/02

(52) U.S. Cl. CPC H04M 1/72575; H04W 12/02; H04B 1/3888

(57) ABSTRACT

The present disclosure relates to a mobile phone case and a controlling method and an electronic device using the same. The mobile phone case according to one embodiment of the present disclosure includes a mobile phone case including a body that is in a first state covering a back surface of a mobile phone or in a second state covering a front surface of the mobile phone, a functional film provided in a bottom part of the body to provide a specific function which modulates light generated from a display of the mobile phone when the body is in the second state, and a magnet provided in the body to change a magnetic field recognized by a magnetic sensor of the mobile phone according to whether the state is the first state or the second state.

### CROSS-REFERENCE TO RELATED APPLICATION

This application claims priority to and the benefit of Korean Patent Application No. 10-2019-0059447, filed on May 21, 2019, the contents of which is incorporated herein by reference in its entirety.

### BACKGROUND

### 1. Field of the Invention

The present disclosure relates to a mobile phone case capable of selectively providing specific functions, and a controlling method and an electronic device using the same.

### 2. Discussion of Related Art

A mobile phone case refers to a device applied to a mobile phone to protect the mobile phone from foreign substances, a shock, and the like. The mobile phone case can includes a normal cover type that covers a back surface of the mobile phone, a bumper type that covers a side surface portion of the mobile phone to protect the mobile phone, a full cover type that covers all surfaces of the mobile phone, a diary type that covers all surfaces of the mobile phone in a folding manner and can accommodate cards, a flip type that covers all surfaces of the mobile phone in a folding manner and cannot accommodate cards, and the like according to a shape thereof.

Meanwhile, there is a functional film attached to displays of various electronic devices to provide specific functions. For example, the functional film includes a presbyopia film, a privacy film, and the like. That is, the presbyopia film provides a vision correction function to a presbyopic user so that the presbyopic user may view a screen more clearly. Further, the privacy film provides a privacy function that makes it difficult for people around the user to see contents of a display unless the people are within an appropriate view position by performing limitation of a viewing angle of the display, a change of multiple views, or the like.

However, in some cases, the user can desire to use the mobile phone without the specific functions. For example, when the privacy is provided, since a user may be provided with a screen of which sharpness or the like is reduced within the appropriate view position, the user may not desire to use the privacy function when people are not around the user.

However, in a conventional mobile phone case, a functional film for a specific function should be attached to a display of a mobile phone to provide a specific function due to the characteristics of the shape of the conventional mobile phone case. Accordingly, even when the specific function is not necessary, the specific function should be continuously provided until the attached functional film is removed.

### SUMMARY OF THE INVENTION

The present disclosure is directed to providing a mobile phone case applied to a mobile phone and capable of selectively providing specific functions, and a controlling method and an electronic device using the same.

Further, the present disclosure is directed to providing a mobile phone case capable of activating and deactivating a specific function of a mobile phone associated with a specific function when the specific function is provided, and a controlling method and an electronic device using the same.

However, technical problems desired to be solved by the present disclosure are not limited to the above-described problems, and other technical problems which are not mentioned may be apparently understood by those skilled in the art from the specification and the accompanying drawings.

According to an aspect of the present disclosure, there is provided a mobile phone case including (1) a body including a side surface part and a bottom part to be in a first state covering a side surface and a back surface of a mobile phone or in a second state covering the side surface and a front surface of the mobile phone, (2) a functional film provided in the bottom part of the body to provide a specific function which modulates light generated from a display of the mobile phone when the body is in the second state, and (3) a magnet provided in the body to change a magnetic field recognized by a magnetic sensor of the mobile phone according to whether the state is the first state or the second state.

According to another aspect of the present disclosure, there is provided a mobile phone case including (1) a body including a side surface part and a bottom part to cover a side surface and a back surface of a mobile phone, (2) a cover connected to the body in a folding manner to be in a first state which is unfolded or in a second state covering a front surface of the mobile phone, (3) a functional film provided in the cover to provide a specific function which modulates light generated from a display of the mobile phone when the cover is in the second state, and (3) a magnet provided in the cover to change a magnetic field recognized by a magnetic sensor of the mobile phone according to whether the state is the first state or the second state.

The functional film may be a presbyopia film providing a vision correction function to presbyopia, or a privacy film providing a privacy function which restricts viewing the display of the mobile phone in an area except for a specific location.

The privacy film may restrict a view angle or provide multiple views to provide the privacy function.

The privacy film may include a micro lens array providing multiple views.

A specific function or a specific application of the mobile phone may be activated or deactivated according to a change in the magnetic field recognized by the magnetic sensor.

At least one specific function among an auto lock function, a message notification function, and a message preview function may be activated or deactivated according to whether the state is the first state or the second state when the functional film is a privacy film which restricts viewing the display of the mobile phone in an area except for a specific location.

The auto lock function may be activated or the message notification function or the message preview function may be deactivated in the second state and when the functional film is a privacy film which restricts viewing the display of the mobile phone in an area except for a specific location.

The auto lock function may be deactivated or the message notification function or the message preview function may be activated in the first state and when the functional film is the privacy film

A specific application combined with a light modulation function of a presbyopia film to provide a vision correction function to presbyopia may be activated in the second state and when the functional film is the presbyopia film providing the vision correction function to the presbyopia

The specific application may be deactivated in the first state and when the functional film is the presbyopia film.

According to still another aspect of the present disclosure, there is provided a controlling method of a mobile phone which adopts a mobile phone case including a body including a side surface part and a bottom part to be in a first state covering a side surface and a back surface of the mobile phone or in a second state covering the side surface and a front surface of the mobile phone, a functional film provided in the bottom part of the body to provide a specific function which modulates light generated from a display of the mobile phone when the body is in the second state, and a magnet provided in the body, the controlling method including (1) recognizing a change in a magnetic field due to the magnet according to whether the state is the first state or the second state, and (2) activating or deactivating the specific function of the mobile phone according to the recognized change in the magnetic field.

According to yet another aspect of the present disclosure, there is provided a controlling method of a mobile phone which adopts a mobile phone case including a body including a side surface part and a bottom part to cover a side surface and a back surface of a mobile phone, a cover connected to the body in a folding manner to be in a first state which is unfolded or in a second state covering a front surface of the mobile phone, a functional film provided in the cover to provide a specific function which modulates light generated from a display of the mobile phone when the cover is in the second state, and a magnet provided in the cover to change a magnetic field recognized by a magnetic sensor of the mobile phone according to whether the state is the first state or the second state, the controlling method including (1) recognizing a change in a magnetic field due to the magnet according to whether the state is the first state or the second state, and (2) activating or deactivating the specific function of the mobile phone according to the recognized change in the magnetic field.

According to yet another aspect of the present disclosure, there is provided an electronic device which adopts a case including a body including a side surface part and a bottom part to be in a first state covering a side surface and a back surface of the electronic device or in a second state covering the side surface and a front surface of the electronic device, a functional film provided in the bottom part of the body to provide a specific function which modulates light generated from a display of the electronic device when the body is in the second state, and a magnet provided in the body, the electronic device including (1) a magnetic sensor configured to sense a magnetic field, and (2) a controller configured to activate or deactivate a specific function of the electronic device according to a value of the magnetic sensor that senses the magnetic field which is changed due to the magnet according to whether the state is the first state or the second state.

According to yet another aspect of the present disclosure, there is provided an electronic device which adopts a case including a body including a side surface part and a bottom part to cover a side surface and a back surface of a mobile phone, a cover connected to the body in a folding manner to be in a first state which is unfolded or in a second state covering a front surface of the mobile phone, a functional film provided in the cover to provide a specific function which modulates light generated from a display of the mobile phone when the cover is in the second state, and a magnet provided in the cover to change a magnetic field recognized by a magnetic sensor of the mobile phone according to whether the state is the first state or the second state, the electronic device including (1) a magnetic sensor configured to sense a magnetic field, and (2) a controller configured to activate or deactivate a specific function of the electronic device according to a value of the magnetic sensor that senses the magnetic field which is changed due to the magnet according to whether the state is the first state or the second state.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 illustrates a case before a mobile phone case according to a first embodiment of the present disclosure is adopted on a side surface and a back surface of a mobile phone (100);

FIG. 2 illustrates a case before the mobile phone case according to the first embodiment of the present disclosure is adopted on the side surface and a front surface of the mobile phone (100);

FIG. 3 illustrates a state in which a cover (21) of a mobile phone case according to a second embodiment of the present disclosure is open;

FIG. 4 illustrates a state in which the cover (21) of the mobile phone case according to the second embodiment of the present disclosure is closed;

FIG. 5 illustrates a configuration diagram of the mobile phone (100) which is an electronic device according to one embodiment of the present disclosure;

FIG. 6 illustrates a case in which a functional film (20) which is a privacy film provides a privacy function due to restriction of a view angle;

FIG. 7 illustrates a case in which a functional film (20) which is a privacy film provides a privacy function due to provision of multiple views; and

FIG. 8 illustrates a flow chart of a controlling method according to one embodiment of the present disclosure.

### DETAILED DESCRIPTION OF EXEMPLARY EMBODIMENTS

The above-described objects and means of the present disclosure and the effects associated therewith will become more apparent through the following detailed description in conjunction with the accompanying drawings. Accordingly, those skilled in the art to which the present disclosure pertains can readily implement the technical spirit of the present disclosure. In addition, when it is determined that detailed descriptions of related well-known functions unnecessarily obscure the gist of the present disclosure during the description of the present disclosure, the detailed descriptions will be omitted.

Terms used herein are for the purpose of describing embodiments only and are not intended to limit the present disclosure. In the present specification, the singular forms “a,” “an,” and “the” are intended to include the plural forms as well in some cases, unless the context clearly indicates otherwise. In the present specification, terms such as “comprises,” “comprising,” “includes,” “including,” “has,” and/or “having,” do not preclude the presence or addition of one or more other components other than the components mentioned.

In the present specification, terms such as “or,” “at least one,” and the like may represent one of the words listed together, or may represent a combination of two or more. For example, “A or B” and “at least one of A and B” may include only one of A or B and may include both A and B.

In the present specification, descriptions following “for example” may not exactly match the information presented, such as cited characteristics, variables, or values, and embodiments of the disclosure according to various embodiments of the present disclosure should not be limited by effects such as modifications including limits of tolerances, measurement errors, and measurement accuracy, and other commonly known factors.

In the present specification, when it is described that one component is “connected” or “joined” to another component, it should be understood that the one component may be directly connected or joined to another component, but additional components may be present therebetween. However, when one component is described as being “directly connected,” or “directly coupled” to another component, it should be understood that additional components may be absent between the one component and another component.

In the present specification, when one component is described as being “on” or “facing” another component, it should be understood that the one component may be directly in contact with or connected to another component, but additional components may be present between the one component and another component. Contrarily, when one component is described as being “directly on” or “in direct contact with” another component, it should be understood that there is no additional component between the one component and another component. Other expressions describing the relationship between components, such as “between ˜,” “directly between ˜,” and the like should be interpreted in the same way

In the present specification, terms such as “first” and “second” may be used to describe various components, but the components should not be limited by the above terms. In addition, the above terms should not be interpreted as limiting the order of each component but may be used for the purpose of distinguishing one component from another. For example, a “first element” could be termed a “second element,” and similarly, a “second element” could also be termed a “first element”.

Unless defined otherwise, all terms used herein may be used in a sense commonly understood by those skilled in the art to which the present disclosure pertains. In addition, it should be understood that terms, such as those defined in commonly used dictionaries, will not be interpreted in an idealized or overly formal sense unless expressly so defined herein.

Hereinafter, an exemplary embodiment of the present disclosure will be described with reference to the accompanying drawings.

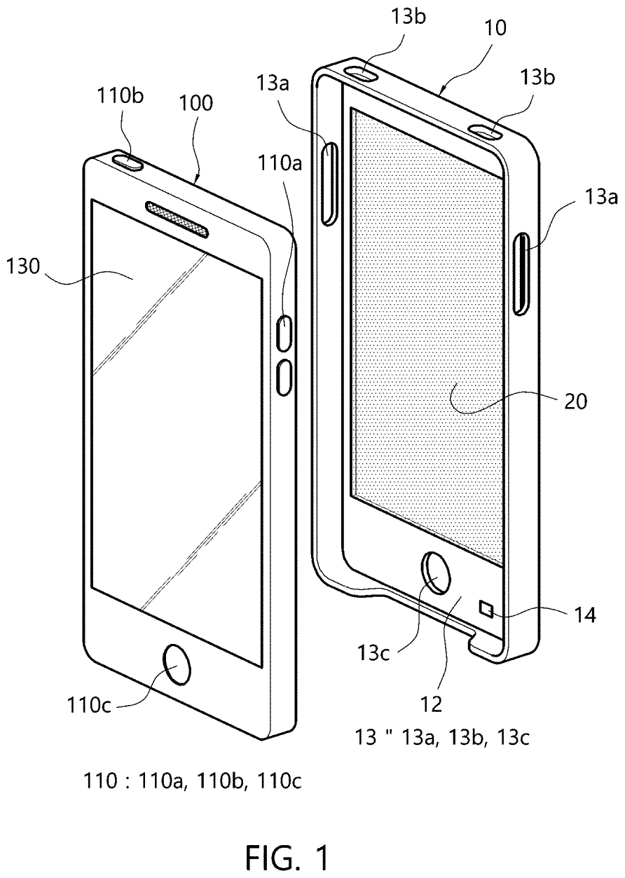

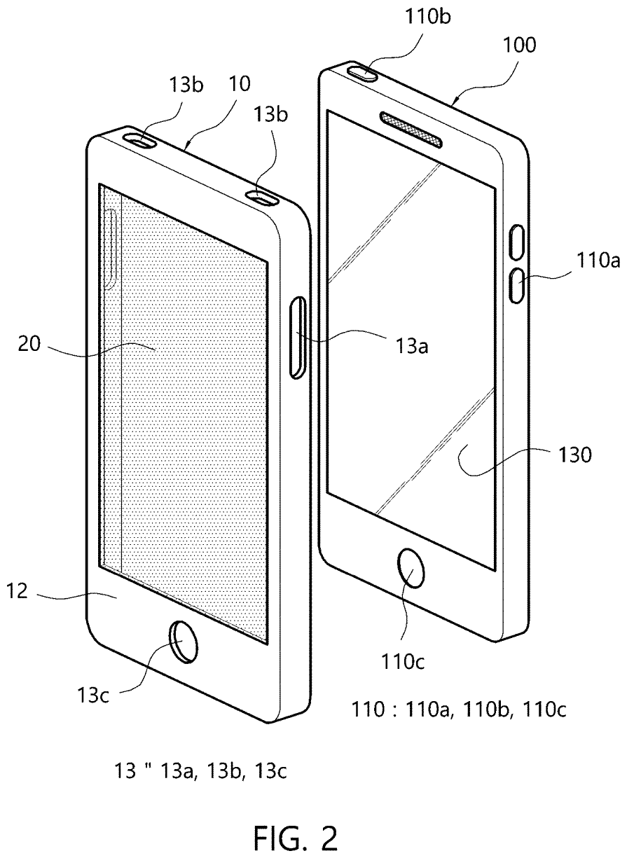

FIG. 1 illustrates a case before a mobile phone case according to a first embodiment of the present disclosure is adopted on a side surface and a back surface of a mobile phone 100 (hereinafter, referred to as “first adoption”), and FIG. 2 illustrates a case before the mobile phone case according to the first embodiment of the present disclosure is adopted on the side surface and a front surface of the mobile phone 100 (hereinafter, referred to as “second adoption”.

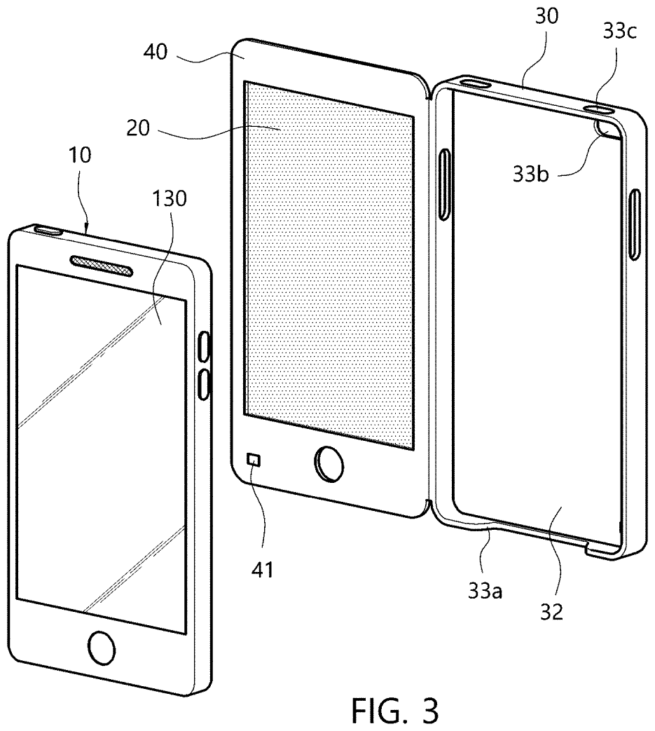

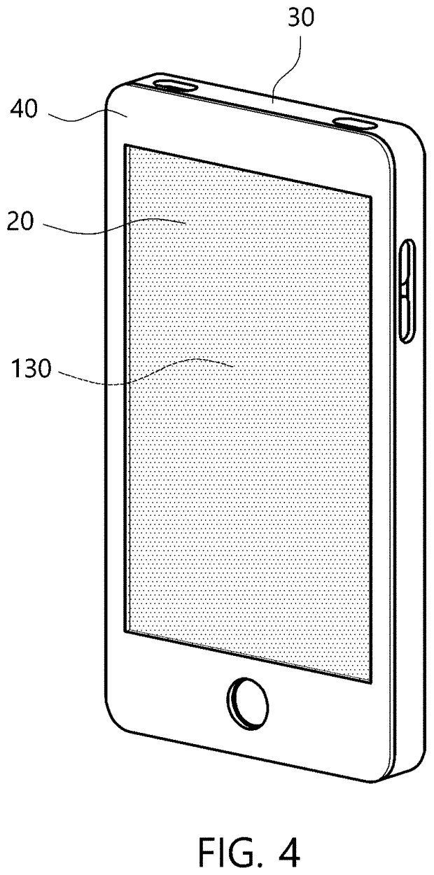

Further, FIG. 3 illustrates a state in which a cover 21 of a mobile phone case according to a second embodiment of the present disclosure is open (hereinafter, referred to as “a first state”), and FIG. 4 illustrates a state in which the cover 21 of the mobile phone case according to the second embodiment of the present disclosure is closed (hereinafter, referred to as “a second state”.

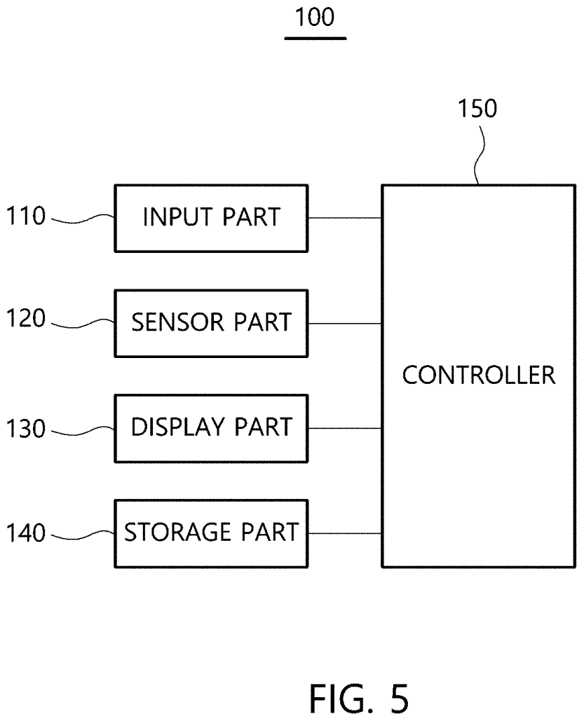

In addition, FIG. 5 illustrates a configuration diagram of the mobile phone 100 which is an electronic device according to one embodiment of the present disclosure.

The mobile phone case according to the first embodiment of the present disclosure is a normal cover type case adopted in the mobile phone 100 to protect the mobile phone 100 from foreign substances, a shock, and the like, and includes a body 10 including a side surface part 11 and a bottom part 12 to partially cover the mobile phone 100, and a functional film 20 provided in the bottom part 12 of the body 10.

As shown in FIG. 1, the body 10 may act as a normal cover type adopted through the first adoption to cover the side surface and the back surface of the mobile phone 100, and as shown in FIG. 2, the body 10 may be adopted through the second adoption to cover the side surface and the front surface of the mobile phone 100.

The side surface part 11 of the body 10 is formed to cover the side surface of the mobile phone 100, and the bottom part 12 of the body 10 is formed to cover the back surface or the front surface of the mobile phone 100.

The side surface part 11 and the bottom part 12 of the body 10 may be provided with a plurality of through parts 13 through which an input part 110 of the mobile phone 100, that is, a sound adjusting button 110a, a power button 110b, a home button 110c, a camera (not shown), and the like may pass. Accordingly, even when the body 10 is adopted on the mobile phone 100, a user may operate the input part 110 of the mobile phone 100 through the through parts 13.

Specifically, in order to allow the first adoption or the second adoption, the through parts 13 may be provided to be laterally symmetrical to each other with respect to a vertical center line of the bottom part 12 of the body 10. Accordingly, regardless of whether the first adoption or the second adoption is adopted, the user may operate the input part 110 which passes through the through parts 13 of the mobile phone 100.

The mobile phone case according to the second embodiment of the present disclosure is a flip type case adopted in the mobile phone 100 to protect the mobile phone 100 from foreign substances, a shock, and the like, and includes a body 30 including a side surface part 31 and a bottom part 32 to cover a side surface and a back surface of the mobile phone 100, a cover 40 connected to the body 30 in a folding manner to cover a front surface of the mobile phone 100 in which a display part 130 of the mobile phone 100 is located, and a functional film 20 provided in the cover 40.

As shown in FIGS. 3 and 4, the body 30 is adopted to cover the side surface and the back surface of the mobile phone 100. The side surface part 31 of the body 30 is formed to cover the side surface of the mobile phone 100, and the bottom part 32 of the body 30 is formed to cover the back surface of the mobile phone 100.

The side surface part 31 and the bottom part 32 of the body 30 may be provided with a plurality of through parts 33 through which an input part 110 of the mobile phone 100, that is, a sound adjusting button 110a, a power button 110b, a home button 110c, camera (not shown), and the like may pass. Accordingly, even when the body 30 is adopted in the mobile phone 100, the user may operate the input part 110 of the mobile phone 100 through the through parts 33.

The functional film 20 is a film provided in a hollow hole of the bottom part 12 or a hollow hole of the cover 40 to provide a specific function of a display of the mobile phone 100, that is, the display part 130. That is, in the case of the mobile phone case of the first embodiment, when the body 10 is adopted in the mobile phone 100 through the second adoption, the functional film 20 provides the specific function for the display part 130 of the mobile phone 100. Further, in the case of the mobile phone case of the second embodiment, when the cover 40 is maintained in the second state in the mobile phone 100, the functional film 20 provides the specific function for the display part 130 of the mobile phone 100.

In the second adoption or the second state, the functional film 20 modulates light generated from the display part 130 of the mobile phone 100. In this case, light modulation is a physical change in which the characteristics of the light such as refraction, reflection, polarization, or the like are adjusted so that properties of light before reaching the functional film 20 and light emitted through the functional film 20 become different. In order to modulate the light, the functional film 20 may be formed of various materials and one or more layers.

For example, the functional film 20 may be a presbyopia film providing a vision correction function of presbyopia to a presbyopic user so that the presbyopic user views a clearer screen, or a privacy film providing a privacy function which restricts viewing the display of the mobile phone in an area except for a specific location.

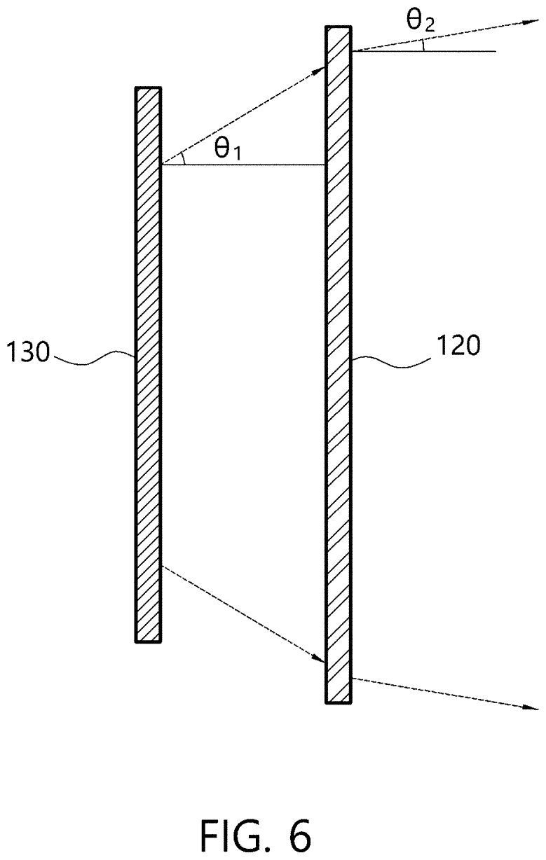

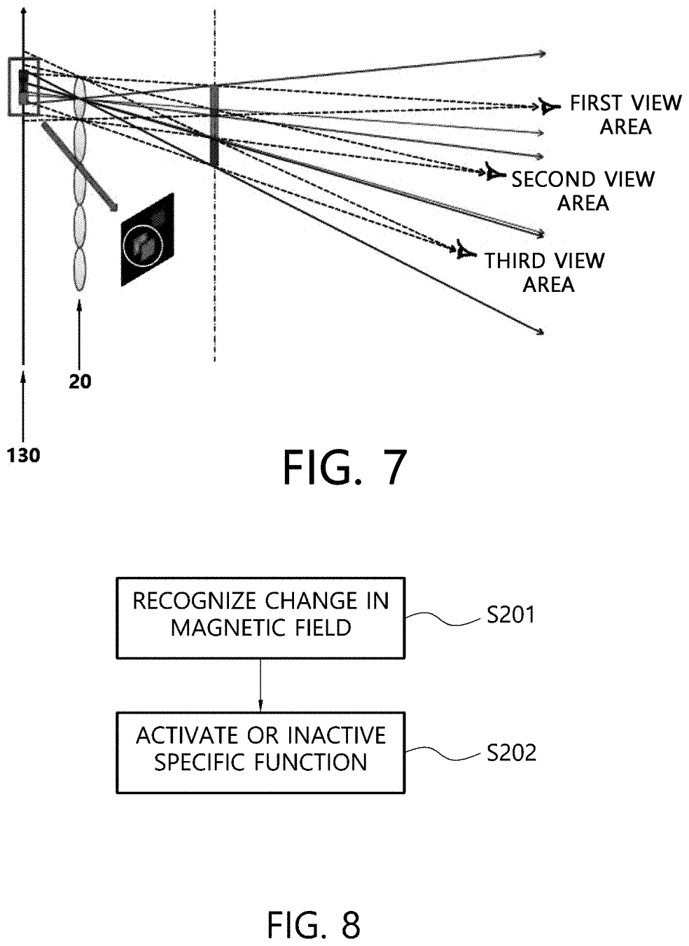

FIG. 6 illustrates a case in which the functional film 20 which is the privacy film provides a privacy function due to restriction of a view angle, and FIG. 7 illustrates a case in which the functional film 20 which is the privacy film provides a privacy function due to provision of multiple views.

Specifically, the privacy film may restrict viewing the display part 130 of the mobile phone in an area except for a specific location through view angle restriction (hereinafter, referred to as “a first action”) or provision of multiple views (hereinafter, referred to as “a second action”).

Referring to FIG. 6, the privacy film may perform the first action to reduce the view angle more than usual by adjusting refractive index or a polarization method of the light passing therethrough. That is, in the first action, a view angle θ2 after the light passes through the privacy film is smaller than a view angle θ1 before the light passes through the privacy film (θ1>θ2). Accordingly, in an area within the view angle θ2, although the display part 130 of the mobile phone may be viewed, in an area at the outside of the view angle θ2, viewing the display part 130 of the mobile phone may be restricted.

Further, referring to FIG. 7, the privacy film may perform the second action to form a plurality of view areas and provide the clearest screen in a specific view area (for example, a first view area) and a blurry screen in the remaining view areas. That is, the privacy film may perform the second action by including a plurality of micro lens arrays. Accordingly, although the display part 130 of the mobile phone may be viewed in the specific view area such as the first view area or the like, viewing the display part 130 of the mobile phone may be restricted in the areas excluding the specific view area.

Meanwhile, in the mobile phone case of the first embodiment, the body 10 may include a magnet 14. In this case, the magnet 14 may be provided to be plural in number and may be provided on a surface or inside of the side surface part 11 or the bottom part 12 of the body 10.

In the mobile phone case of the first embodiment, the magnet 14 may change a magnetic field recognized by a magnetic sensor of a sensor part 120 of the mobile phone 100 according to whether the first adoption or the second adoption of the body 10 to the mobile phone 100 is performed. That is, the magnet 14 may cause a change in the magnetic field so that a magnetic field recognized by the magnetic sensor of the mobile phone 100 when the body 10 is adopted in the mobile phone 100 through the first adoption (hereinafter, referred to as “a first magnetic field”), and a magnetic field sensed by the magnetic sensor of the mobile phone 100 when the body 10 is adopted in the mobile phone 100 through the second adoption (hereinafter, referred to as “a second magnetic field”) may be different from each other.

Further, in the mobile phone case of the second embodiment, the cover 40 may include a magnet 41. In this case, the magnet 41 may be provided to be plural in number and may be provided on a surface or inside of the cover 40.

In the mobile phone case of the second embodiment, the magnet 41 may change a magnetic field recognized by a magnetic sensor of the sensor part 120 of the mobile phone 100 according to whether the cover 40 is in the first state or the second state. That is, the magnet 41 may cause a change in the magnetic field so that a first magnetic field recognized by the magnetic sensor of the mobile phone 100 when the cover 40 is in the first state and a second magnetic field sensed by the magnetic sensor of the mobile phone 100 when the cover 40 is in the second state may be different from each other.

Since each of the magnets 14 and 41 causes the change in the magnetic field sensed by the magnetic sensor of the mobile phone 100, a specific function or a specific application of the mobile phone 100 may be induced to be activated or deactivated (hereinafter, referred to as “specific function provision”).

Meanwhile, the mobile phone 100 which is the electronic device according to one embodiment of the present disclosure having the function of a mobile phone may be a smartphone, a mobile phone, or the like. However, the electronic device according to one embodiment of the present disclosure is not limited to the mobile phone 100. For example, the electronic device according to one embodiment of the present disclosure may be one of a smartpad, a tablet personal computer, a laptop personal computer, a netbook computer, and personal digital assistant (PDA) but is not limited thereto.

As shown in FIG. 5, the electronic device according to one embodiment of the present disclosure may include the input part 110, the sensor part 120, the display part 130, a storage part 140, and a controller 150. In this case, the electronic device according to one embodiment of the present disclosure may adopt the above-described mobile phone case of first embodiment through the first adoption or the second adoption or maintain the above-described cover 40 of the adopted mobile phone case of the second embodiment in the first state or the second state.

The input part 110 generates input data corresponding to input of the user. The input part 110 includes various input units. For example, the input part 110 may include the sound adjusting button 110a, the power button 110b, the home button 110c, the camera (not shown), and the like.

The sensor part 120 recognizes an action such as an external force to generate sensor data. The sensor part 120 includes various sensors. For example, the sensor part 120 may include a magnetic sensor (Hall sensor), an acceleration sensor, a gyro sensor, a proximity sensor, a light sensor, a temperature/humidity sensor, and the like.

The display part 130 displays various image data. For example, the display part 130 may include a liquid crystal display (LCD), a light emitting diode (LED) display, an organic light emitting diode (OLED) display, a micro electro mechanical systems (MEMS) display, and an electronic paper display. Further, the display part 130 may be coupled to the input part 120 to be implemented as a touch screen or the like.

The storage part 140 stores various information and programs necessary to operate the mobile phone 100. The storage part 140 may store information of a sensing value of the sensor part 120 configured to recognize the first magnetic field or the second magnetic field which are changed due to the magnet 14 according to whether the mobile phone case is adopted in the mobile phone 100 through the first adoption or the second adoption.

For example, the storage part 140 may be one of a hard disk type, a magnetic media type, compact disc read only memory (CD-ROM) type, an optical media type, a magneto-optical media type, a multimedia card micro type, a flash memory type, a read only memory (ROM) type, and a random access memory (RAM) type according to the type thereof, but is not limited thereto. Further, the storage part 140 may be a cache, a buffer, a main memory unit, an auxiliary memory unit, or a separately provided storage system according to the usage/position thereof, but is not limited thereto.

The controller 150 may perform various control operations, and specifically, may perform a control operation providing a specific function according to whether the mobile phone case of the first embodiment is adopted on the mobile phone 100 through the first adoption or the second adoption or whether the cover 40 of the mobile phone case of the second embodiment is in the first state or the second state. For example, the controller 150 may be a processor or a control program which operates in the processor. Further, the controller 150 may control operations of the input part 110, the sensor part 120, the display part 130, and the storage part 140.

Hereinafter, a controlling method according to one embodiment of the present disclosure operated by the controller 150 will be described.

FIG. 8 illustrates a flow chart of the controlling method according to one embodiment of the present disclosure.

Referring to FIG. 8, the controlling method according to one embodiment of the present disclosure includes operations S201 and S202.

In operation S201, the controller 150 recognizes a change in the magnetic field due to the magnets 14 and 41 according to whether the mobile phone case of the first embodiment is adopted through the first adoption or the second adoption or whether the cover 40 of the mobile phone case of the second embodiment is in the first state or the second state. That is, the controller 150 detects a value of the magnetic sensor of the sensor part 120 that senses the magnetic field to recognize the change in the magnetic field according to whether the mobile phone case of the first embodiment is adopted through the first adoption or the second adoption. Further, the controller 150 detects the value of the magnetic sensor of the sensor part 120 that senses the magnetic field to recognize the change in the magnetic field according to whether the cover 40 of the mobile phone case of the second embodiment is in the first state or the second state.

In addition, in operation S202, the controller 150 may activate or deactivate a specific function or a specific application of the mobile phone 100 according to the recognized change in the magnetic field.

When the mobile phone case is provided with a presbyopia film, the specific application of the mobile phone 100 may be an application associated with the vision correction function, for example, an application combined with the light modulation of the presbyopia film so that the presbyopic user may view a clearer screen.

That is, users having presbyopia may have different presbyopic vision. However, since a physical characteristic of the light modulation by the presbyopia film has a predetermined characteristic, it is impossible to provide vision correction functions that cause different light modulations to all presbyopic vision using only the presbyopia film. Accordingly, the specific application of the mobile phone 100 may provide an environment in which the presbyopic vision of the user may be measured or receive a presbyopic vision value of the user. The specific application may provide a display environment adjusted for a light modulation characteristic of the presbyopia film to provide the vision correction function using the presbyopic vision value of the user. For example, the specific application may adjust and control a size, a shape, a color, brightness, or the like of a text according to the presbyopic vision value of the user for display.

When the body 10 of the mobile phone case of the first embodiment including the presbyopia film is adopted in the mobile phone 100 through the second adoption, or the cover 40 of the mobile phone case of the second embodiment including the presbyopia film is in the second state, the controller 150 which recognizes the adoption or the state through the value of the magnetic sensor of the sensor part 120 may be set so that the specific application associated with the vision correction function is activated in the mobile phone 100.

Further, when the body 10 of the mobile phone case including the presbyopia film is adopted in the mobile phone 100 through the first adoption, or the cover 40 of the mobile phone case of the second embodiment including the presbyopia film is in the first state, the controller 150 which recognizes the adoption or the state through the value of the magnetic sensor of the sensor part 120 may be set so that the specific application associated with the vision correction function is deactivated in the mobile phone 100. However, whether the specific application is activated or deactivated may be determined according to setting of the user.

Further, when the mobile phone case is provided with the privacy film, the specific function or the specific application of the mobile phone 100 may be a function or application associated with the privacy function and, for example, may be a function or application associated with at least one of an auto lock function, a message notification function, and a message preview function.

The auto lock function refers to a function which may be changed to a state in which the mobile phone 100 is usable by performing password input, specific touch operation input, specific drag operation input, specific motion operation input, finger print recognition, face recognition, iris recognition, or the like when the mobile phone 100 is in a standby screen. Accordingly, when the privacy function is provided by the privacy film, the auto lock function may be activated.

That is, when the body 10 of the mobile phone case of the first embodiment including the privacy film is adopted in the mobile phone 100 through the second adoption or the cover 40 of the mobile phone case of the second embodiment including the privacy film is in the second state and thus the privacy function is provided by the privacy film, since the controller 150 which recognizes the adoption or the state through the value of the magnetic sensor of the sensor part 120 may be set so that the auto lock function is activated in the mobile phone 100, an additional privacy function may be provided.

Further, when the body 10 of the mobile phone case of the first embodiment including the privacy film is adopted in the mobile phone 100 through the first adoption and thus the privacy function is not provided by the privacy film or the cover 40 of the mobile phone case of the second embodiment including the privacy film is in the first state and thus the privacy function is not provided by the privacy film, the controller 150 which recognizes the adoption or the state through the value of the magnetic sensor of the sensor part 120 may be set so that the auto lock function is deactivated in the mobile phone 100 t. However, whether the auto lock function is activated or deactivated may be determined according to setting of the user.

The message notification function refers to a function providing notifications of reception of Short Message Service (SMS), Multimedia Messaging Service (MMS), instant messages, or the like to a standby screen when the mobile phone 100 is in the standby screen. Accordingly, when the privacy function is provided by the privacy film, the auto lock function may be deactivated.

That is, when the body 10 of the mobile phone case of the first embodiment including the privacy film is adopted in the mobile phone 100 through the second adoption and thus the privacy function is provided by the privacy film or the cover 40 of the mobile phone case of the second embodiment including the privacy film is in the second state and thus the privacy function is provided by the privacy film, since the controller 150 which recognizes the adoption or the state through the value of the magnetic sensor of the sensor part 120 may be set so that the auto lock function is deactivated in the mobile phone 100, the additional privacy function may be provided.

Further, when the body 10 of the mobile phone case of the first embodiment including the privacy film is adopted in the mobile phone 100 through the first adoption and thus the privacy function is not provided by the privacy film or the cover 40 of the mobile phone case of the second embodiment including the privacy film is in the first state and thus the privacy function is not provided by the privacy film, the controller 150 which recognizes the adoption or the state through the value of the magnetic sensor of the sensor part 120 may be set so that the message notification function is activated in the mobile phone 100. However, whether the message notification function is activated or deactivated may be determined according to setting of the user.

When the mobile phone 100 is in the standby screen, the message preview function refers to a function providing some or all contents of SMS, MMS, instant messages, or the like to the standby screen in the case in which SMS, MMS, instant messages, or the like are received. Accordingly, when the privacy function is provided by the privacy film, the message preview function may be deactivated.

That is, when the body 10 of the mobile phone case of the first embodiment including the privacy film is adopted in the mobile phone 100 through the second adoption and thus the privacy function is provided by the privacy film or the cover 40 of the mobile phone case of the second embodiment including the privacy film is in the second state and thus the privacy function is provided by the privacy film, since the controller 150 which recognizes the adoption or the state through the value of the magnetic sensor of the sensor part 120 may be set so that the message preview function is deactivated in the mobile phone 100, the additional privacy function may be provided.

Further, when the body 10 of the mobile phone case of the first embodiment including the privacy film is adopted in the mobile phone 100 through the first adoption and thus the privacy function is not provided by the privacy film or the cover 40 of the mobile phone case of the second embodiment including the privacy film is in the first state and thus the privacy function is not provided by the privacy film, the controller 150 which recognizes the adoption or the state through the value of the magnetic sensor of the sensor part 120 may be set so that the message preview function is activated in the mobile phone 100. However, whether the message preview function is activated or deactivated may be determined according to setting of the user.

That is, in summary, when the body 10 of the mobile phone case of the first embodiment including the privacy film is adopted in the mobile phone 100 through the second adoption, or the cover 40 of the mobile phone case of the second embodiment including the privacy film is in the second state, the magnetic sensor of the sensor part 120 senses the second magnetic field (S201). Accordingly, the controller 150 may control functions so that the auto lock function is activated or the message notification function or the message preview function is deactivated (S202).

Further, when the body 10 of the mobile phone case of the first embodiment including the privacy film is adopted in the mobile phone 100 through the first adoption, or the cover 40 of the mobile phone case of the second embodiment including the privacy film is in the first state, the magnetic sensor of the sensor part 120 senses the first magnetic field (S201). Accordingly, the controller 150 may control functions so that the auto lock function is deactivated or the message notification function or the message preview function is activated (S202).

According to the present disclosure, specific functions such as a vision correction function, a privacy function, and the like adopted in a mobile phone can be selectively provided.

Further, according to the present disclosure, when specific functions are provided, since specific functions of the mobile phone associated with the specific functions can be activated or deactivated, the specific functions can be enhanced.

While specific embodiments have been described in the detailed description of the present disclosure, various modifications may be made without departing from the scope of the present disclosure. Therefore, the scope of the present disclosure is defined not by the described embodiment but by the appended claims and encompasses equivalents that fall within the scope of the appended claims.

What is claimed is:

1. A mobile phone case comprising:
a body including a side surface part and a bottom part to be in a first state covering a side surface and a back surface of a mobile phone or in a second state covering the side surface and a front surface of the mobile phone;
a functional film provided in the bottom part of the body to provide a specific function which modulates light generated from a display of the mobile phone when the body is in the second state; and
a magnet provided in the body to change a magnetic field recognized by a magnetic sensor of the mobile phone according to whether the state is the first state or the second state.

2. The mobile phone case of claim 1, wherein the functional film is a presbyopia film providing a vision correction function to presbyopia, or a privacy film providing a privacy function which restricts viewing the display of the mobile phone in an area except for a specific location.

3. The mobile phone case of claim 2, wherein the privacy film restricts a view angle or provides multiple views to provide the privacy function.

4. The mobile phone case of claim 2, wherein the privacy film includes a micro lens array providing multiple views.

5. The mobile phone case of claim 1, wherein a specific function or a specific application of the mobile phone is activated or deactivated according to a change in the magnetic field recognized by the magnetic sensor.

6. The mobile phone case of claim 5, wherein at least one specific function among an auto lock function, a message notification function, and a message preview function is activated or deactivated according to whether the state is the first state or the second state when the functional film is a privacy film which restricts viewing the display of the mobile phone in an area except for a specific location.

7. The mobile phone case of claim 5, wherein:
an auto lock function is activated or a message notification function or a message preview function is deactivated in the second state and when the functional film is a privacy film which restricts viewing the display of the mobile phone in an area except for a specific location; and
the auto lock function is deactivated or the message notification function or the message preview function is activated in the first state and when the functional film is the privacy film.

8. The mobile phone case of claim 5, wherein:
a specific application combined with a light modulation function of a presbyopia film to provide a vision correction function to presbyopia is activated in the second state and when the functional film is the presbyopia film providing the vision correction function to the presbyopia; and
the specific application is deactivated in the first state and when the functional film is the presbyopia film.

9. A mobile phone case comprising:
a body including a side surface part and a bottom part to cover a side surface and a back surface of a mobile phone;
a cover connected to the body in a folding manner to be in a first state which is unfolded or in a second state covering a front surface of the mobile phone;
a functional film provided in the cover to provide a specific function which modulates light generated from a display of the mobile phone when the cover is in the second state; and
a magnet provided in the cover to change a magnetic field recognized by a magnetic sensor of the mobile phone according to whether the state is the first state or the second state.

10. The mobile phone case of claim 9, wherein the functional film is a presbyopia film providing a vision correction function to presbyopia, or a privacy film providing a privacy function which restricts viewing the display of the mobile phone in an area except for a specific location.

11. The mobile phone case of claim 10, wherein the privacy film restricts a view angle or provides multiple views to provide the privacy function.

12. The mobile phone case of claim 10, wherein the privacy film includes a micro lens array providing multiple views.

13. The mobile phone case of claim 9, wherein a specific function or a specific application of the mobile phone is activated or deactivated according to a change in the magnetic field recognized by the magnetic sensor.

14. The mobile phone case of claim 13, wherein at least one specific function among an auto lock function, a message notification function, and a message preview function is activated or deactivated according to whether the state is the first state or the second state when the functional film is a privacy film which restricts viewing the display of the mobile phone in an area except for a specific location.

15. The mobile phone case of claim 13, wherein:
an auto lock function is activated or a message notification function or a message preview function is deactivated in the second state and when the functional film is a privacy film which restricts viewing the display of the mobile phone in an area except for a specific location; and
the auto lock function is deactivated or the message notification function or the message preview function is activated in the first state and when the functional film is the privacy film.

16. The mobile phone case of claim 13, wherein:
a specific application combined with a light modulation function of a presbyopia film to provide a vision correction function to presbyopia is activated in the second state and when the functional film is the presbyopia film providing the vision correction function to the presbyopia; and
the specific application is deactivated in the first state and when the functional film is the presbyopia film.

17. A controlling method of a mobile phone which adopts a mobile phone case that is in a first state covering a back surface of the mobile phone or in a second state covering a front surface of the mobile phone,
wherein the mobile phone case includes a magnet, and a functional film providing a specific function which modulates light generated from a display of the mobile phone in the second state,
the controlling method comprising:
recognizing a change in a magnetic field due to the magnet according to whether the state is the first state or the second state; and
activating or deactivating the specific function of the mobile phone according to the recognized change in the magnetic field.

18. An electronic device which adopts a case that is in a first state covering a back surface of the electronic device or in a second state covering a front surface of the electronic device,
wherein the case includes a magnet, and a functional film providing a specific function which modulates light generated from a display of the electronic device in the second state,
the electronic device comprising:
a magnetic sensor configured to sense a magnetic field; and
a controller configured to activate or deactivate a specific function of the electronic device according to a value of the magnetic sensor configured to sense the magnetic field which is changed due to the magnet according to whether the state is the first state or the second state.
